(19) United States
(12) Patent Application Publication
(10) Pub. No.: US 2010/0156822 A1
(43) Pub. Date: Jun. 24, 2010

(54) TOUCH-SENSITIVE INTERFACE DEVICE

(75) Inventors: Kyungno LEE, Seoul (KR); Il-Kweon Joung, Seongnam-si (KR)

Correspondence Address: MCDERMOTT WILL & EMERY LLP, 600 13TH STREET, N.W., WASHINGTON, DC, 20005-3096, US

(73) Assignee: SAMSUNG ELECTRO-MECHANICS CO., LTD.

(21) Appl. No.: 12/571,783

(22) Filed: Oct. 1, 2009

(30) Foreign Application Priority Data
Dec. 24, 2008 (KR) 10-2008-0133191

(51) Int. Cl. G06F 3/041

(52) U.S. Cl. 345/173; 340/407.1

(57) ABSTRACT

A touch-sensitive interface device is disclosed. The touch-sensitive interface device according to an embodiment of the invention can include a touchscreen, an image display panel coupled to one face of the touchscreen, a driving unit that vibrates the touchscreen in a direction parallel to the face of the touchscreen such that the tactile feel at the surface of the touchscreen is changed, and a control unit that controls the operating frequency of the driving unit. The touch-sensitive interface device can vibrate the touchscreen in a direction parallel to a face of the touchscreen, providing the user with a sensation that the tactile feel changes at the portion that the user touches.

### CROSS-REFERENCE TO RELATED APPLICATIONS

This application claims the benefit of Korean Patent Application No. 10-2008-0133191, filed with the Korean Intellectual Property Office on Dec. 24, 2008, the disclosure of which is incorporated herein by reference in its entirety.

### BACKGROUND

1. Technical Field

The present invention relates to a touch-sensitive interface device.

2. Description of the Related Art

A touchscreen is a type of input device where a user may press a particular area with a finger or a stylus pen to enter an input. The touchscreen may transfer an input signal corresponding to the pressed position to the electronic apparatus on which the touchscreen is equipped.

However, when a user presses a particular area on the touchscreen, there is no feedback to the user that allows the user to check whether or not the input has been entered correctly.

Responding to this difficulty, devices that include a vibration motor, etc., together with the touch panel have recently been developed. A user input on the touch panel may trigger the vibration motor, causing the entire electronic apparatus to vibrate. However, this feedback is not directly related to the particular area pressed by the user, and the touchscreen device does not provide an appealing sensory feel.

### SUMMARY

An aspect of the invention provides a touch-sensitive interface device capable of providing feedback in the form of a tactile feel in response to a user maneuvering a touchscreen.

Another aspect of the invention provides touch-sensitive interface device that includes: a touchscreen; a driving unit that can vibrate the touchscreen in a direction parallel to one face of the touchscreen such that a surface of the touchscreen is given a different tactile feel; and a control unit that can adjust an operating frequency of the driving unit.

Here, the control unit may control the driving unit in such a way that the driving unit vibrates the touchscreen at different frequencies depending on a pressed position of the touchscreen. In certain embodiments, an operating frequency of the driving unit can be within a range of an ultrasonic waves, and in some examples, an operating frequency of the driving unit can be at above the audible frequency range.

The driving unit may include a piezoelectric component.

Also, the driving unit may be coupled to one side of the touchscreen, and the touch-sensitive interface device may include more than one driving units. In certain embodiments, there may be driving units coupled to both sides of the touchscreen, or there may be a driving unit coupled to one side of a perimeter of one face of the touchscreen.

The touch-sensitive interface device can further include a protective panel, which may be coupled to one side of the touchscreen. The driving unit can be coupled to one side of the protective panel to change the tactile feel of a surface of the protective panel.

A portion of the touchscreen can be partitioned into a virtual tactile presentation area, and the control unit can control the driving unit such that the driving unit vibrates the touchscreen at different frequencies depending on whether or not a pressed position of the touchscreen lies within the tactile presentation area.

In certain embodiments, the touch-sensitive interface device can further include an image display panel coupled to one face of the touchscreen, where the driving unit can be coupled to one side of the image display panel.

A multiple number of icons can be displayed on the image display panel, with the tactile presentation area formed between adjacent icons. Here, the tactile presentation area can be formed in an annular shape along a perimeter of an icon.

In certain embodiments, a scrollbar can be displayed on the image display panel, with the tactile presentation area formed discontinuously along the direction in which the scrollbar is extended. If the scrollbar has an annular shape, the tactile presentation area can be formed in a radial shape on the scrollbar.

Additional aspects and advantages of the present invention will be set forth in part in the description which follows, and in part will be obvious from the description, or may be learned by practice of the invention.

### BRIEF DESCRIPTION OF THE DRAWINGS

FIG. 1 is a perspective view of a touch-sensitive interface device according to a first disclosed embodiment of the invention.

FIG. 2 and FIG. 3 are diagrams illustrating the operating principle of a touch-sensitive interface device according to the first disclosed embodiment of the invention.

FIG. 4 illustrates a first mode for a mobile phone equipped with a touch-sensitive interface device according to the first disclosed embodiment of the invention.

FIG. 5 illustrates a second mode for a mobile phone equipped with a touch-sensitive interface device according to the first disclosed embodiment of the invention.

FIG. 6 illustrates a third mode for a mobile phone equipped with a touch-sensitive interface device according to the first disclosed embodiment of the invention.

FIG. 7 illustrates a fourth mode for a mobile phone equipped with a touch-sensitive interface device according to the first disclosed embodiment of the invention.

FIG. 8 illustrates a fifth mode for a mobile phone equipped with a touch-sensitive interface device according to the first disclosed embodiment of the invention.

FIG. 9 illustrates a sixth mode for a mobile phone equipped with a touch-sensitive interface device according to the first disclosed embodiment of the invention.

FIG. 10 illustrates a seventh mode for a mobile phone equipped with a touch-sensitive interface device according to the first disclosed embodiment of the invention.

FIG. 11 is a perspective view of a touch-sensitive interface device according to a second disclosed embodiment of the invention.

FIG. 12 is a perspective view of a touch-sensitive interface device according to a third disclosed embodiment of the invention.

FIG. 13 is a perspective view of a touch-sensitive interface device according to a fourth disclosed embodiment of the invention.

FIG. 14 is a perspective view of a touch-sensitive interface device according to a fifth disclosed embodiment of the invention.

FIG. 15 is a perspective view of a touch-sensitive interface device according to a sixth disclosed embodiment of the invention.

FIG. 16 is a perspective view of a touch-sensitive interface device according to a seventh disclosed embodiment of the invention.

### DETAILED DESCRIPTION

The touch-sensitive interface device according to certain embodiments of the invention will be described below in more detail with reference to the accompanying drawings. Those elements that are the same or are in correspondence are rendered the same reference numeral regardless of the figure number, and redundant descriptions are omitted.

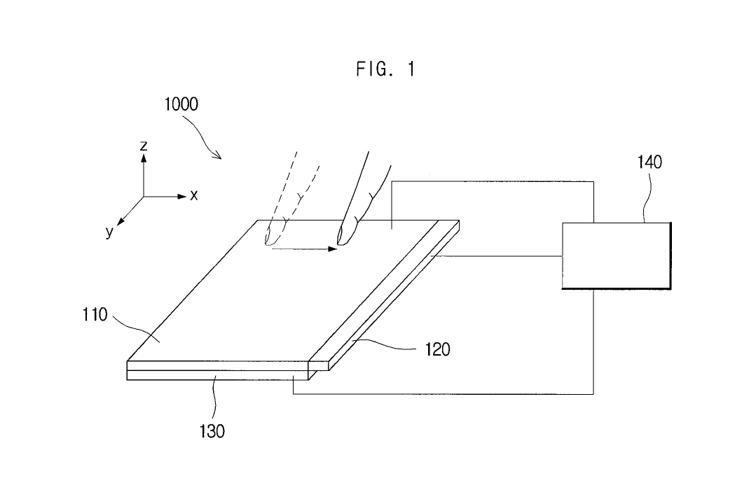

FIG. 1 is a perspective view of a touch-sensitive interface device according to a first disclosed embodiment of the invention. As in the example shown in FIG. 1, a touch-sensitive interface device 1000 according to an embodiment of the invention can include a touchscreen 110, an image display panel 130 coupled to one face of the touchscreen 110, a driving unit 120 that vibrates the touchscreen 110 in a direction parallel to the face of the touchscreen 110 such that the tactile feel at the surface of the touchscreen is changed, and a control unit 140 that controls the operating frequency of the driving unit 120. Thus, the touch-sensitive interface device 1000 may provide a sensation that the tactile feel changes at the portion that the user touches.

The touch-sensitive interface device 1000 can be an input device in which information can be inputted by a user's touch and a corresponding feedback can be supplied to the user in the form of a change in tactile feel at the portion that the user touches.

Thus, the touch-sensitive interface device 1000 may be employed as an input unit for a portable electronic apparatus, such as a mobile phone 400, PDA (personal digital assistant), PMP (portable multimedia player), and MP3 (MPEG Audio Layer-3) player, for example, as well as for other electronic apparatus, such as a GPS navigation system, computer monitor, ATM (automatic teller machine), game console, and information kiosk. In such apparatus, a user may press a particular position on a touchscreen 110, at which the information related to the pressed position may be transferred to the control unit 140.

In certain embodiments where the touch-sensitive interface device 1000 also includes an image display panel 130, the touch-sensitive interface device 1000 can serve as both an input and an output unit.

The image display panel 130 can be coupled to a face of the touchscreen 110. The image display panel 130 can be a part capable of displaying an image, such as an LCD panel, for example, and can function as an output unit for the electronic apparatus on which the touch-sensitive interface device 1000 is installed.

The image display panel 130 can be electrically connected with the control unit 140, which will be described later in more detail. Instructions from the control unit 140 can cause the image display panel 130 to display a variety of images, according to the operational status of the electronic apparatus to which the touch-sensitive interface device 1000 is installed. The image display panel 130 can display various items, such as icons 410 and scrollbars 415, for example, that allow the user to select menu choices.

The driving unit 120 can vibrate the touchscreen 110 in a direction parallel to the touchscreen 110, such that the tactile feel at the surface of the touchscreen 110 is changed. The driving unit 120, which may use a piezoelectric component, for example, can be formed in the shape of a bar and can be coupled to one side of the touchscreen 110. A piezoelectric component can implement various forms of high-frequency vibrations according to the direction of polarity. In the example shown in FIG. 1, the piezoelectric component may vibrate the touchscreen 110 in the direction of the x-axis.

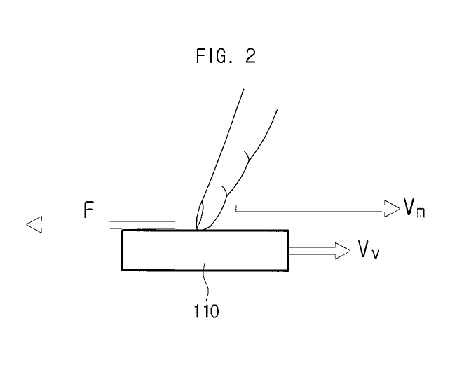

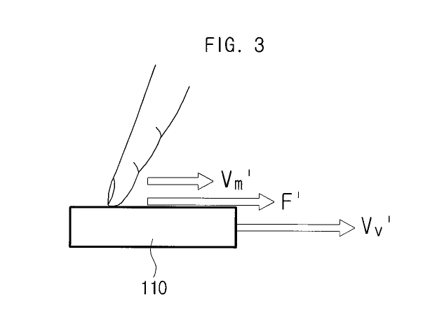

FIG. 2 and FIG. 3 are diagrams illustrating the operating principle of a touch-sensitive interface device 1000 according to the first disclosed embodiment of the invention. As illustrated in FIG. 2, if the user moves along the surface of the touchscreen 110 while touching the surface, a vibration on the touchscreen 110 that is applied at a speed (Vᵥ) slower than the speed (Vₘ) of the movement of the user's finger can cause the user to sense a friction (F) in the direction opposite to the movement of the finger, in addition to the texture of the surface of the touchscreen 110.

However, as illustrated in FIG. 3, if the touchscreen 110 vibrates at a speed (Vᵥ′) that is faster than the speed (Vₘ′) of the user's finger, the user can sense a friction (F′) in the same direction as the direction of movement of the user' finger. In other words, the user can feel that the friction has decreased at the surface of the touchscreen 110.

Numerous receptors exist in a person's skin, each receptor transferring different information to the brain according to the frequency range. Among these receptors, Pacinian corpuscles sense vibrations within a frequency range of 10 to 500 Hz.

Therefore, by vibrating the touchscreen 110 at a frequency higher than 500 Hz, the driving unit 120 can provide sensory information that is perceived by the user not as a vibration, but as a change in tactile feel, caused by the reduction in friction at the surface of the touchscreen 110.

The range of frequencies perceived as vibrations may vary for each user. However, if the touchscreen 110 vibrates at a frequency of 1 kHz, for example, most users will perceive this as a change in tactile feel of the surface of the touchscreen 110.

Also, if the frequency of the driving unit 120 is above the audible frequency range, i.e. above 20 kHz—within a range of an ultrasonic waves—(for example, when a piezoelectric component is used, a frequency of up to 600 kHz may be obtained), the vibration of the touchscreen 110 may not be perceived by the user as noise. Thus, the user may perceive only the information provided in the form of a changed tactile feel on the surface of the touchscreen 110.

The control unit 140 can be electrically connected with the driving unit 120 and can control the operating frequency of the driving unit 120. The control unit 140 can be electrically connected not only with the driving unit 120 but also with the touchscreen 110 and the image display panel 130, to control their operation.

The control unit 140 can be implemented as a separate set of circuitry for controlling the operation of the touch-sensitive interface device 1000 or can be implemented as a part of the device that controls the operation of the electronic apparatus on which the touch-sensitive interface device 1000 is installed.

The control unit 140 may receive information regarding the pressed position from the touchscreen 110 and may control the driving unit 120 to vibrate the touchscreen 110 at different frequencies according to the pressed position.

That is, if the position where the user presses is changed, the control unit 140 may accordingly change the operating frequency of the driving unit 120 so as to provide the user with a sensation that the tactile feel of the surface of the touchscreen 110 is continuously being changed.

The control unit 140 may control the vibration amplitude of the driving unit 120 not only by controlling the operating frequency but also by controlling the voltage supplied to the driving unit 120. The vibration amplitude of the driving unit 120 is a major factor, together with the operating frequency, that determines the tactile feel of the touchscreen 110 surface. Even at the same operating frequency, the user can be provided with different tactile sensations according to the magnitude of the voltage supplied.

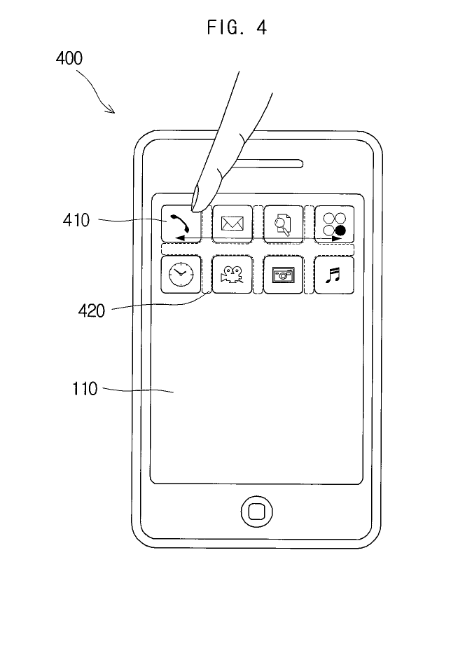

FIG. 4 illustrates a first mode for a mobile phone 400 equipped with a touch-sensitive interface device 1000 according to the first disclosed embodiment of the invention. The touch-sensitive interface device 1000 can be applied to a mobile phone 400 to receive input from the user, output certain modes of the mobile phone 400 through the image display panel 130, and provide a varying tactile feel by the vibration of the touchscreen 110.

As in the example illustrated in FIG. 4, the image display panel 130 can display a number of icons 410. The multiple number of icons 410 can be displayed on the image display panel 130 in a grid-like arrangement. Here, the control unit 140 can partition a portion of the touchscreen 110 as a virtual tactile presentation area 420.

The tactile presentation area 420 can be a partitioned area on the touchscreen 110 where the user can be provided with a tactile feel for the surface of the touchscreen 110 within the tactile presentation area that is different from the tactile feel for the surface of the touchscreen 110 outside the tactile presentation area 420.

The tactile presentation area 420 can be configured in various forms according to the arrangement of images, such as icons 410 and scrollbars 415, displayed on the image display panel 130 for receiving input from the user.

For example, if there are icons 410 displayed on the image display panel 130, the tactile presentation area 420 can be configured on the touchscreen to coincide with the positions and shapes of the icons 410, to separate the areas occupied by the icons 410 from other areas. Alternatively, the tactile presentation area 420 can be configured on the touchscreen to represent areas excluding the areas occupied by the icons 410.

That is, the tactile presentation area 420 can be formed between multiple icons 410. If the pressed position lies outside the tactile presentation area 420, the control unit 140 can abstain from providing an operating signal to the driving unit 120, allowing the user to feel the natural texture of the touchscreen 110 surface.

However, if the pressed position on the touchscreen 110 lies inside the tactile presentation area 420, the control unit 140 can provide an operating signal to the driving unit 120 that causes the driving unit 120 to vibrate the touchscreen 110 at 500 Hz or higher.

Thus, if the user moves a finger over multiple icons 410, the portions between the icons 410 can provide the user with a different tactile sensation from that provided the portions where the icons 410 are displayed. As such, it will be felt by the user that the surface of the touchscreen 110 is partitioned into virtual areas having different tactile feels.

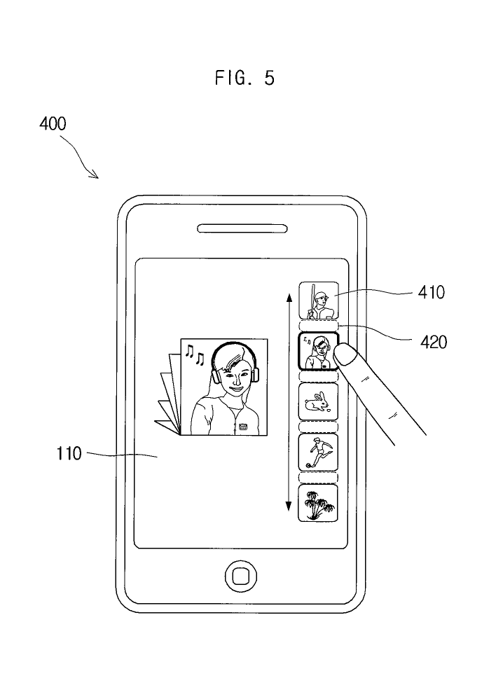

FIG. 5 illustrates a second mode for a mobile phone 400 equipped with a touch-sensitive interface device 1000 according to the first disclosed embodiment of the invention. As in the example illustrated in FIG. 5, the image display panel 130 can display a photo saved in the mobile phone 400, with multiple icons 410 displayed on one side in a longitudinal direction to be used to select other photos.

The multiple number of icons 410 can be partitioned by tactile presentation areas 420. If the pressed position on the touchscreen 110 lies within a tactile presentation area 420, the control unit 140 can provide an operating signal to the driving unit 120, to vibrate the touchscreen 110 at 500 Hz or higher and provide the user with the sensation that the tactile feel of the surface of the touchscreen 110 has changed.

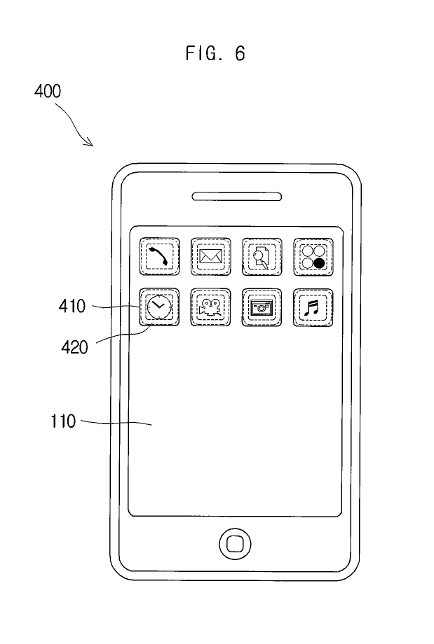

FIG. 6 illustrates a third mode for a mobile phone 400 equipped with a touch-sensitive interface device 1000 according to the first disclosed embodiment of the invention. As in the example illustrated in FIG. 6, the image display panel 130 can display a number of icons 410, with a tactile presentation area 420 partitioning a portion of the touchscreen 110 in an annular shape along the perimeter of each of the icons 410.

If the pressed position on the touchscreen 110 lies inside a tactile presentation area 420, the touchscreen 110 can vibrate at 500 Hz or higher, so that the user may perceive a different tactile feel at the boundaries of the icons 410. This can enable the user to perceive the icons 410 through both visual and tactile sensations.

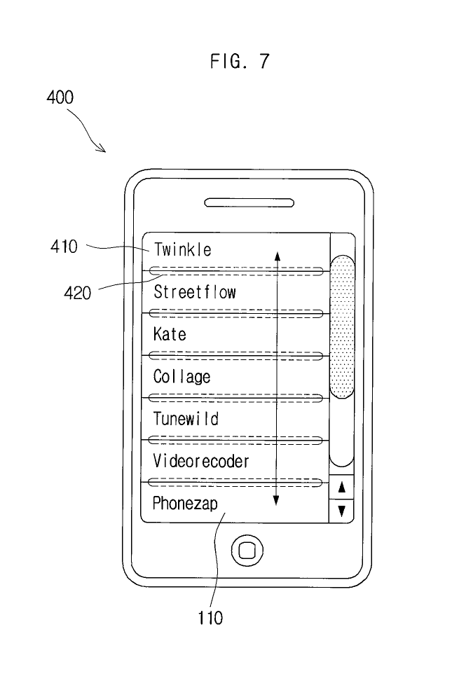

FIG. 7 illustrates a fourth mode for a mobile phone 400 equipped with a touch-sensitive interface device 1000 according to the first disclosed embodiment of the invention. As in the example illustrated in FIG. 7, the image display panel 130 can display laterally-extending icons 410 that are arranged in a longitudinal direction. In this case, the tactile presentation areas 420 can be formed in the portions adjacent to the icons 410, along the lateral direction in which the icons 410 extend.

Thus, if the user moves upwards or downwards along the surface of the touchscreen 110, the user may sense different tactile feels for the areas displaying the icons 410 and the areas between icons 410, receiving a sensory feel that is generally congruous with the images displayed on the image display panel 130.

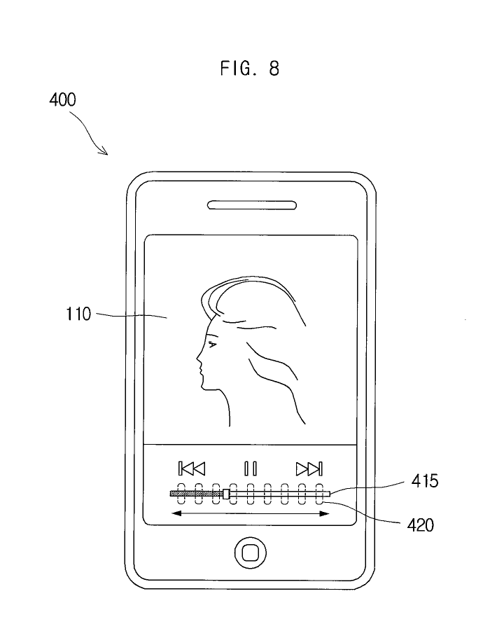

FIG. 8 illustrates a fifth mode for a mobile phone 400 equipped with a touch-sensitive interface device 1000 according to the first disclosed embodiment of the invention. In a mode for playing an audio file saved in the mobile phone 400, as in the example illustrated in FIG. 8, the image display panel 130 can display a horizontal scrollbar 415 for adjusting the volume.

Here, the tactile presentation areas 420 can be formed discontinuously in the same direction as the scrollbar 415. Each tactile presentation area 420 can be arranged along the scrollbar 415 in certain intervals, to partition a portion of the touchscreen 110.

Thus, if the user moves along the scrollbar 415 to adjust the volume, the user may sense different tactile feels as the user's finger follows the scrollbar 415, receiving a sensation that the tactile feel is being changed.

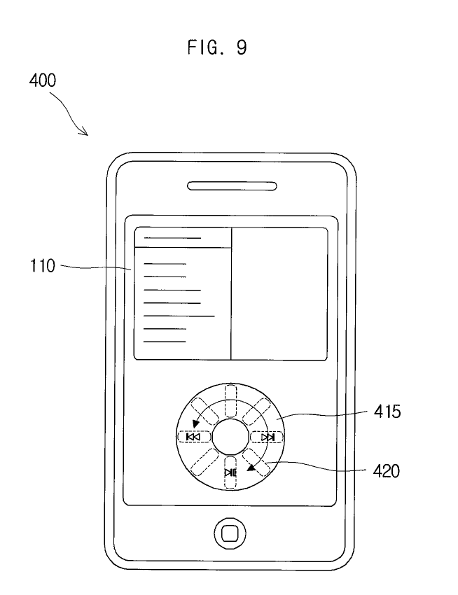

FIG. 9 illustrates a sixth mode for a mobile phone 400 equipped with a touch-sensitive interface device 1000 according to the first disclosed embodiment of the invention. As in the example illustrated in FIG. 9, the image display panel 130 may on certain occasions display a scrollbar 415 having an annular shape, such as when saving an audio file recorded by the mobile phone 400.

On such occasions, the tactile presentation areas 420 can be formed discontinuously along the circular direction of the scrollbar 415, on the touchscreen 110 where the scrollbar 415 is displayed. Thus, the user may sense different tactile feels as the user's finger moves along the annular scrollbar 415, receiving a sensation that the tactile feel is being changed.

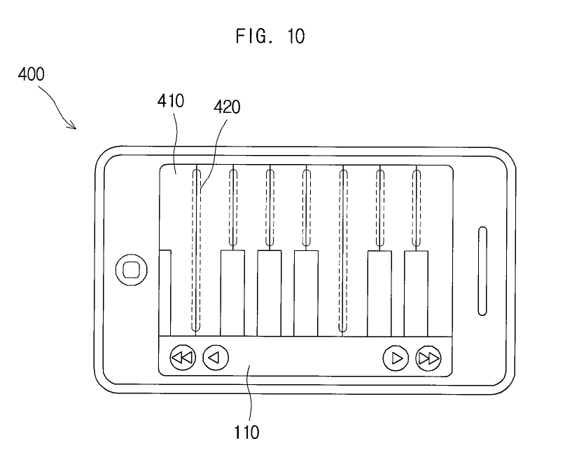

FIG. 10 illustrates a seventh mode for a mobile phone 400 equipped with a touch-sensitive interface device 1000 according to the first disclosed embodiment of the invention. As in the example illustrated in FIG. 10, a gaming function on the mobile phone 400 may include, for example, a piano keyboard displayed on the image display panel 130. The keys on the keyboard can correspond to the icons 410, which the user may maneuver to input information, and the tactile presentation areas 420 can be formed between the keys.

Thus, the user may perceive a different tactile feel while touching the touchscreen 110 on a portion between keys, to receive a sensation that the tactile feel is changed.

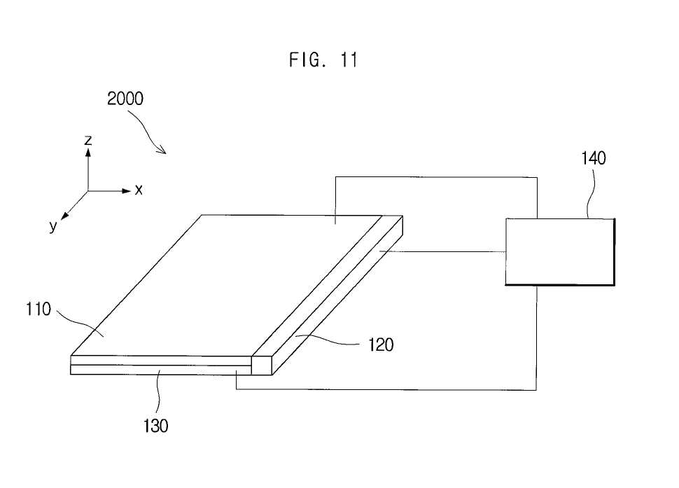

FIG. 11 is a perspective view of a touch-sensitive interface device 2000 according to a second disclosed embodiment of the invention. As illustrated in FIG. 11, a touch-sensitive interface device 2000 according to the second disclosed embodiment of the invention can have the driving unit 120 coupled to one side of the touchscreen 110 and the image display panel 130 together.

As such, the touchscreen 110 and the image display panel 130 integrated with the driving unit 120 can be vibrated together in the direction of the x-axis. This can prevent losses in vibration that may otherwise occur as the driving unit 120 transfers the vibration to the touchscreen 110, so that sufficient vibration may be transferred to the touchscreen 110.

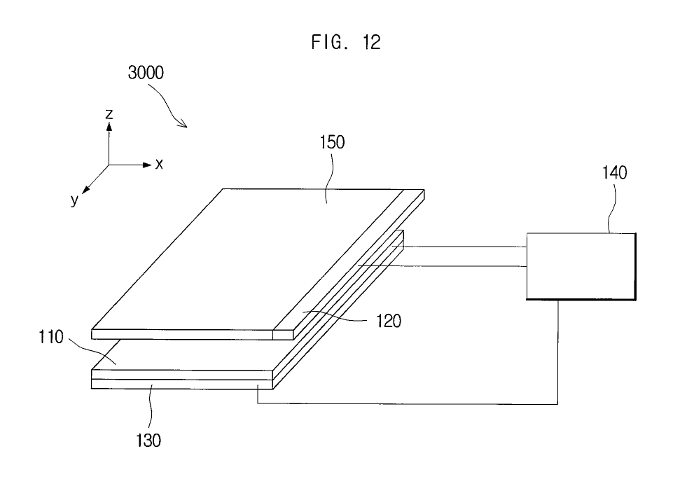

FIG. 12 is a perspective view of a touch-sensitive interface device 3000 according to a third disclosed embodiment of the invention. As illustrated in FIG. 12, a touch-sensitive interface device 3000 according to the third disclosed embodiment of the invention can further include a protective panel 150 for protecting the touchscreen 110, coupled to a face of the touchscreen 110.

The protective panel 150 can protect the surface of the touchscreen 110, and can be the portion that the user touches directly. Here, the driving unit 120 can be coupled to one side of the protective panel 150 to provide a vibration in the direction of the x-axis, whereby the change in tactile feel may be delivered directly to the user.

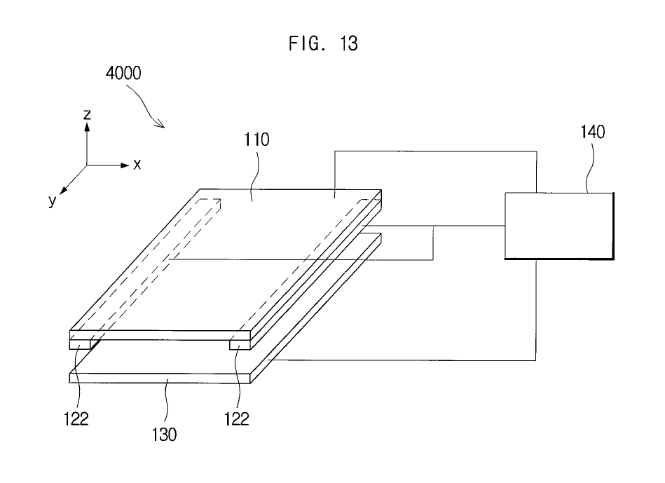

FIG. 13 is a perspective view of a touch-sensitive interface device 4000 according to a fourth disclosed embodiment of the invention. As illustrated in FIG. 13, a touch-sensitive interface device 4000 according to the fourth disclosed embodiment of the invention can have the driving units 122 coupled to one side on the face of the touchscreen 110, as well as to the opposite side.

The driving units 122 can be implemented with piezoelectric components, which may be polarized in such a way that allows vibration in the direction of the x-axis. In certain embodiments, the driving units 122 can be coupled to both sides of the touchscreen 110 to provide sufficient vibration to the touchscreen 110.

The driving units 122 can be coupled to portions other than the areas where the images are displayed on the image display panel 130.

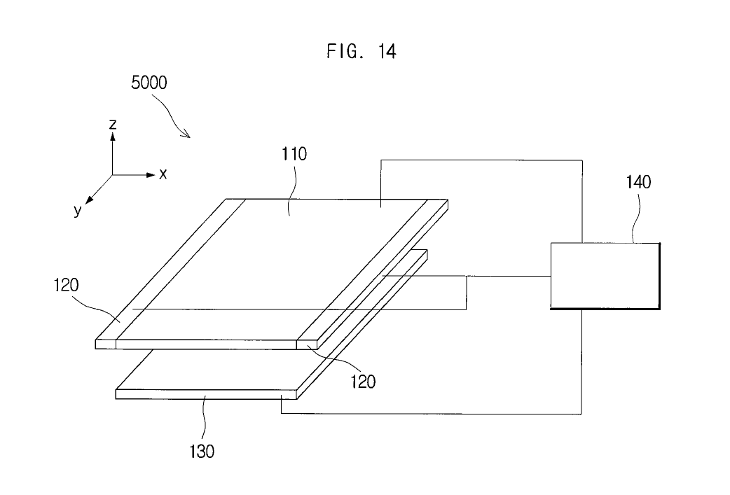

FIG. 14 is a perspective view of a touch-sensitive interface device 5000 according to a fifth disclosed embodiment of the invention. As illustrated in FIG. 14, a touch-sensitive interface device 5000 according to the fifth disclosed embodiment of the invention can have the driving units 120 coupled to both sides of the touchscreen 110. Thus, the driving units 120 may provide sufficient vibration to the touchscreen 110 in the direction of the x-axis.

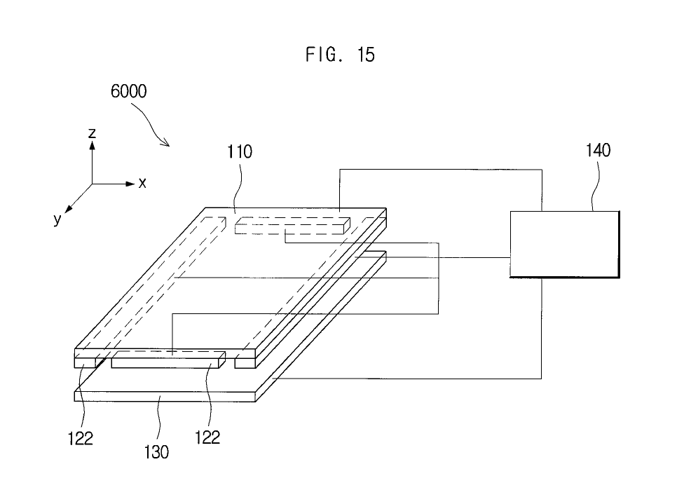

FIG. 15 is a perspective view of a touch-sensitive interface device 6000 according to a sixth disclosed embodiment of the invention. As illustrated in FIG. 15, a touch-sensitive interface device 6000 according to the sixth disclosed embodiment of the invention can have the driving units 122 coupled onto the perimeter of one face of the touchscreen 110.

According to the direction of polarization of the piezoelectric component, i.e. the driving units 122, the touchscreen 110 can be made to vibrate in various directions, such as along the x-axis and y-axis. Thus, by vibrating the touchscreen 110 in the direction of the x-axis when the user's finger moves along the surface of the touchscreen 110 in the x direction, and vibrating the touchscreen 110 in the direction of the y-axis when the user's finger moves along the surface of the touchscreen 110 in the y direction, the same difference in tactile feel can be provided, regardless of the direction of the user's movement.

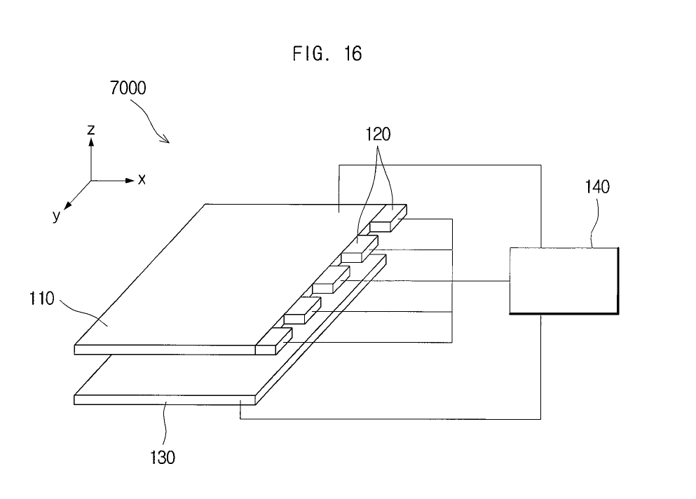

FIG. 16 is a perspective view of a touch-sensitive interface 7000 device according to a seventh disclosed embodiment of the invention. As illustrated in FIG. 16, a touch-sensitive interface device 7000 according to the seventh disclosed embodiment of the invention can have multiple driving units 120 along one side of the touchscreen 110.

Here, each of the driving units 120 can vibrate the touchscreen 110 at the same frequency, and in this way, the driving units 120 can implement sufficient vibration on the touchscreen 110. However, the driving units 120 can also be made to vibrate the touchscreen 110 at different frequencies, providing the user with different tactile feels according to the pressed position on the touchscreen 110.

While the spirit of the invention has been described in detail with reference to particular embodiments, the embodiments are for illustrative purposes only and do not limit the invention. It is to be appreciated that those skilled in the art can change or modify the embodiments without departing from the scope and spirit of the invention.

What is claimed is:

1. A touch-sensitive interface device comprising:
a touchscreen;
a driving unit configured to vibrate the touchscreen in a direction parallel to one face of the touchscreen such that a tactile feel of a surface of the touchscreen is changed; and
a control unit configured to adjust an operating frequency of the driving unit.

2. The touch-sensitive interface device of claim 1, wherein the control unit is configured to control the driving unit such that the driving unit vibrates the touchscreen at different frequencies depending on a pressed position of the touchscreen.

3. The touch-sensitive interface device of claim 1, wherein an operating frequency of the driving unit is within a range of an ultrasonic waves.

4. The touch-sensitive interface device of claim 3, wherein the operating frequency of the driving unit is above an audible frequency range.

5. The touch-sensitive interface device of claim 1, wherein the driving unit comprises a piezoelectric component.

6. The touch-sensitive interface device of claim 1, wherein the driving unit is coupled to one side of the touchscreen.

7. The touch-sensitive interface device of claim 6, comprising a plurality of driving units.

8. The touch-sensitive interface device of claim 7, wherein the driving units are coupled to both sides of the touchscreen.

9. The touch-sensitive interface device of claim 1, wherein the driving unit is coupled to one side of a perimeter of one face of the touchscreen.

10. The touch-sensitive interface device of claim 1, further comprising a protective panel coupled to one face of the touchscreen,
wherein the driving unit is coupled to one side of the protective panel so as to change a tactile feel of a surface of the protective panel.

11. The touch-sensitive interface device of claim 1, wherein a portion of the touchscreen is partitioned into a virtual tactile presentation area, and
the control unit is configured to control the driving unit such that the driving unit vibrates the touchscreen at different frequencies depending on whether or not a pressed position of the touchscreen lies within the tactile presentation area.

12. The touch-sensitive interface device of claim 11, further comprising an image display panel coupled to one face of the touchscreen.

13. The touch-sensitive interface device of claim 12, wherein the driving unit is coupled to one side of the image display panel.

14. The touch-sensitive interface device of claim 12, wherein the image display panel displays a plurality of icons, and
the tactile presentation area is formed between adjacent icons.

15. The touch-sensitive interface device of claim 12, wherein the image display panel displays an icon, and
the tactile presentation area is formed in an annular shape along a perimeter of the icon.

16. The touch-sensitive interface device of claim 12, wherein the image display panel displays a scrollbar, and
the tactile presentation area is formed discontinuously along an extending direction of the scrollbar.

17. The touch-sensitive interface device of claim 15, wherein the scrollbar has an annular shape, and
the tactile presentation area is formed in a radial shape on the scrollbar.
